(19) United States
(12) Patent Application Publication
(10) Pub. No.: US 2019/0024441 A1
(43) Pub. Date: Jan. 24, 2019

(54) GRIPPING DEVICE AND PROCESS FOR MANUFACTURING AN INSULATING GLAZING UNIT

(71) Applicant: SAINT-GOBAIN GLASS FRANCE, Courbevoie (FR)

(72) Inventor: Sébastien HERVIEUX, Choisy Au Bac (FR)

(21) Appl. No.: 16/067,292

(22) PCT Filed: Dec. 31, 2016
(86) PCT No.: PCT/FR2016/053693

§ 371 Date: Jun. 29, 2018

(30) Foreign Application Priority Data
Dec. 31, 2015 (FR) 1563509

(51) Int. Cl. E06B 3/663; E06B 3/673

(52) U.S. Cl. CPC E06B 3/66319; E06B 3/66366; E06B 3/67382; E06B 3/67326; E06B 3/67369; E06B 3/67308

(57) ABSTRACT

A gripping device is configured to hold an insulating glazing subassembly including a spacer frame and at least one central glass sheet received in an internal peripheral groove of the spacer frame. The gripping device includes, on the one hand, members for gripping the spacer frame and, on the other hand, members for gripping the central glass sheet so as to ensure an independent gripping of the spacer frame and of the central glass sheet while allowing a relative movement of one with respect to the other.

The present invention relates to a gripping device and to a process for manufacturing an insulating glazing unit having at least three glass sheets. The invention also relates to a plant for manufacturing insulating glazing units.

Structures of insulating glazing units containing at least three glass sheets are known in which the or each central glass sheet is inserted into an internal peripheral groove of a spacer frame and the outer glass sheets are added to the lateral faces of the spacer frame. The assembling of the insulating glazing subassembly comprising the spacer frame and the or each central glass sheet received in the internal peripheral groove of the spacer frame, then the handling of this subassembly for the following steps of manufacturing the insulating glazing unit, are difficult to automate.

It is these drawbacks that the invention more particularly intends to rectify by providing a gripping device making it possible to manufacture an insulating glazing unit containing at least three glass sheets in an automated manner, while still guaranteeing optimal assembly quality for the insulating glazing unit. For this purpose, one object of the invention is a gripping device, characterized in that it is configured to hold an insulating glazing subassembly comprising a spacer frame and at least one central glass sheet received in an internal peripheral groove of the spacer frame, the gripping device comprising, on the one hand, members for gripping the spacer frame and, on the other hand, members for gripping the central glass sheet so as to ensure an independent gripping of the spacer frame and of the central glass sheet while allowing a relative movement of one with respect to the other.

By means of the invention, it is possible to have a differentiated gripping of the spacer frame, on the one hand, and of the central glass sheet, on the other hand, which is particularly important in the insulating glazing unit manufacturing steps where the spacer frame is mechanically stressed, in order to avoid a stressing of the central glass sheet capable of leading to a breakage of the central glass sheet. This possibility of differentiated gripping makes it possible to automate the insulating glazing unit manufacturing process, while limiting the risk of breakage of the glass sheets and the risk of an assembly defect of the insulating glazing unit. The result of this is an improved durability of the insulating glazing unit obtained.

Within the context of the invention, a “glass sheet” is understood to mean any type of transparent substrate suitable for its role in an insulating glazing unit. It may be a sheet of mineral glass, in particular an oxide glass that may be a silicate, borate, sulfate, phosphate, or other. As a variant, it may be a sheet of organic glass, for example of polycarbonate or of polymethyl methacrylate.

According to one aspect of the invention, each member for gripping the spacer frame is mounted on a retractable arm so as to free up access to the entire periphery of the spacer frame, in particular for the steps of assembling the spacer frame around the central glass sheet and of depositing a seal on the spacer frame. Advantageously, each member for gripping the spacer frame is borne by a frame of the gripping device.

In one embodiment, the gripping device comprises a bearing element in the vicinity of each member for gripping the spacer frame, this bearing element being intended to create a bearing point against a side wall of the spacer frame so as to limit a movement of the spacer frame in the direction of the frame of the gripping device, in particular during a pressing step. Advantageously, each bearing element is suitable for not degrading a seal optionally present on the side wall of the spacer frame that it supports, in particular each bearing element is a needle.

According to one aspect of the invention, each member for gripping the central glass sheet is mounted on an actuator, with a possibility of elastic releasing of the rod of the actuator so that the member for gripping the central glass sheet allows the central glass sheet to accompany the movement of the spacer frame when the latter is mechanically stressed, in particular during pressing steps. Such steps of pressing the spacer frame take place, in particular, during the assembling, in particular by welding, of the ends of the constituent profiles of the spacer frame at each corner of the spacer frame, and during the mounting of outer glass sheets to the spacer frame by application of each outer glass sheet against the corresponding side wall of the spacer frame.

Thus, each member for gripping the central glass sheet is suitable for ensuring a rigid gripping of the central glass sheet, when the rod of the actuator is prevented from moving in translation, or else on the contrary a flexible gripping of the central glass sheet, when the rod of the actuator is left slidingly movable against an elastic load. Advantageously, the elastic load is suitably chosen so that the central glass sheet smoothly accompanies the movement of the spacer frame when the latter is mechanically stressed.

In one embodiment, each member for gripping the central glass sheet is a suction pad borne by a frame of the gripping device.

According to an aspect of the invention, the gripping device is configured to hold the insulating glazing subassembly, comprising the spacer frame and the central glass sheet received in the internal peripheral groove of the spacer frame, in a station for assembling the spacer frame around the central glass sheet.

According to another aspect of the invention, the gripping device is configured to move the insulating glazing subassembly, comprising the spacer frame and the central glass sheet received in the internal peripheral groove of the spacer frame, through a plant for manufacturing insulating glazing units.

Another object of the invention is a process for manufacturing an insulating glazing unit, comprising the assembling of an insulating glazing subassembly which comprises a spacer frame and at least one central glass sheet, and the movement of this insulating glazing subassembly through a plant for manufacturing insulating glazing units, the insulating glazing subassembly being held during at least some steps of the process with the aid of a gripping device as described above.

According to one aspect of the invention, the process for manufacturing an insulating glazing unit comprises:
a step of assembling, in particular by welding, the ends of the constituent profiles of the spacer frame at each corner of the spacer frame when the profiles are gripping the edges of the central glass sheet,
a step of depositing a seal at the periphery of the spacer frame on each side wall of the spacer frame intended to be adjacent to an outer glass sheet of the insulating glazing unit,

and, during these steps of assembling the spacer frame and of depositing a seal, the insulating glazing subassembly is held with the aid of the gripping device in a configuration where each member for gripping the spacer frame is retracted so as to free up access to the periphery of the spacer frame.

According to an aspect of the invention, the process for manufacturing an insulating glazing unit comprises:
a step of assembling, in particular by welding, the ends of the constituent profiles of the spacer frame at each corner of the spacer frame when the profiles are gripping the edges of the central glass sheet,
a step of mounting at least one outer glass sheet to the spacer frame by pressing the outer glass sheet against the corresponding side wall of the spacer frame,

and, during these steps of assembling the spacer frame and of mounting an outer glass sheet, the insulating glazing subassembly is held with the aid of the gripping device in a configuration where each member for gripping the central glass sheet provides a flexible gripping of the central glass sheet, so that the central glass sheet smoothly accompanies the movement of the spacer frame.

In one embodiment, the spacer frame is formed of four profiles angularly assembled at their ends, where each profile has a groove for receiving one edge of the central glass sheet, and the assembling of the insulating glazing subassembly comprises successive steps wherein:
the four edges of the central glass sheet are inserted into the grooves of the four profiles;
the ends of the profiles are assembled, in particular by welding, at each corner of the spacer frame without an alignment bracket, using the edges of the central glass sheet inserted in the grooves of the profiles as a frame of reference for guiding the profiles at each corner of the spacer frame into a configuration where their end faces are aligned by superposition in one and the same plane.

Such assembling of the spacer frame around the central glass sheet guarantees a precise positioning of the end faces of the profiles bearing against one another at each corner of the frame, since the edges of the central glass sheet inserted in the grooves of the profiles provide a profile-guiding function. Consequently, the use of alignment brackets for the assembling at the corners of the spacer frame is not necessary. Advantageously, as the insertion of alignment brackets in the profiles is not required, it is possible to carry out the process according to the invention in an automated manner, which makes it possible to increase the productivity and reduce the production costs of insulating glazing units.

According to one feature, at each corner of the spacer frame, prior to the assembling of the ends of the two profiles forming the corner, the end faces of the two profiles are held in a configuration where they are aligned by superposition in one and the same plane, by the grooves of the two profiles gripping the two corresponding edges of the central glass sheet so as to surround the corner of the central glass sheet at the junction of the two edges.

In one preferred embodiment, the ends of the profiles are assembled at each corner of the spacer frame by ultrasonic welding.

Advantageously, at each corner of the spacer frame, during the ultrasonic welding of the ends of the two profiles, the sonotrode(s) of the welding device surround the corner of the spacer frame by being applied against an outer transverse wall of each of the two profiles. For this purpose, several sonotrode geometries are possible. In one embodiment, at each corner of the spacer frame, the assembling of the ends of the two profiles is carried out using two sonotrodes oriented perpendicular with respect to one another, which are configured in order to surround the corner of the spacer frame by each being applied against the outer transverse wall of one of the two profiles. As a variant, at each corner of the spacer frame, the assembling of the ends of the two profiles may be carried out using a single sonotrode having two vibration transmission surfaces oriented perpendicular with respect to one another, which are configured in order to surround the corner of the spacer frame with each vibration transmission surface that is applied against the outer transverse wall of one of the two profiles.

Preferably, for each profile of the spacer frame, the pressing force exerted during the welding by the sonotrode on the outer transverse wall of the profile is substantially perpendicular to the transverse wall, in order to avoid uncontrolled deformations of the profile. Furthermore, it is advantageous for the welding device to comprise stops suitable for coming into the immediate vicinity of the side walls of the profiles at each corner of the spacer frame during the welding, so that the profiles are confined in a restricted space between the stops, the sonotrode(s) and the central glass sheet during the welding at each corner of the spacer frame. This makes it possible to limit the deformations of the profiles and the appearance of undesirable overthicknesses at the surface, which are liable to give rise to sealing defects of the insulating glazing unit. In particular, surface defects in the side walls of the spacer frame that are intended to be adjacent to the outer glass sheets of the insulating glazing unit may cause discontinuities of the seals that provide the bond between the outer glass sheets and the spacer frame, which reduces the impermeability and the durability of the insulating glazing unit.

In an insulating glazing unit, the spacer frame is conventionally attached to the periphery of the two outer glass sheets with the aid of a peripheral seal, in the form of a bead of mastic generally based on polyisobutylene, or butyl, which is particularly efficient in terms of impermeability to water vapor and to gases. The glass sheets are held together and against the spacer frame by an external sealing barrier, which is applied over the entire outer perimeter of the spacer frame between the two outer glass sheets. The external sealing barrier may be formed, in particular, from a resin chosen from polysulfides, polyurethanes, silicones, hot-melt butyls, and combinations or mixtures thereof. These sealing products have a good adhesion to the glass sheets and mechanical properties that enable them to ensure that the glass components are held against the spacer.

According to one feature, at each corner of the spacer frame, the central glass sheet has a support function opposite the or each sonotrode, which holds the two profiles in a fixed position during the welding. The central glass sheet absorbs some of the energy due to the vibrations during the welding.

The frequency of the ultrasonic vibration for the welding at each corner of the spacer frame is of the order of 15 kHz to 40 kHz, preferably of the order of 30 kHz to 35 kHz. This preferred range of frequencies ensures a sufficient amplitude of the vibrations to make it possible to carry out remote welding, while avoiding damaging the surfaces and having a reasonable size of the components of the welding device.

In one embodiment, the assembling of the ends of the profiles is carried out simultaneously at the four corners of the spacer frame.

Preferably, for each profile of the spacer frame, each end face of the profile is inclined relative to the outer transverse wall of the profile at an angle of the order of 45°, so that the profile is capable of being assembled as a miter cut with the two adjacent profiles of the spacer frame.

Each profile of the spacer frame may be formed of metal and/or of polymer material. Examples of suitable metal materials include, in particular, aluminum or stainless steel. Examples of suitable polymer materials include, in particular, polyethylene (PE), polycarbonate (PC), polypropylene (PP), polystyrene, polybutadiene, polyesters, polyurethanes, polymethyl methacrylate, polyacrylates, polyamides, polyethylene terephthalate (PET), polybutylene terephthalate (PBT), acrylonitrile-butadiene-styrene (ABS), acrylonitrile-styrene-acrylate (ASA), styrene-acrylonitrile copolymer (SAN). Any combination or mixture of these materials can also be envisaged, for example each profile of the spacer frame may be based on polypropylene comprising a reinforcement formed by a stainless steel film. When it is based on polymer material, the profile is advantageously reinforced by fibers, in particular glass or carbon fibers. In one embodiment, each profile of the spacer frame is based on thermoplastic polymer.

According to one aspect of the invention, each profile of the spacer frame comprises at least two tubular portions and the groove for receiving one edge of the central glass sheet is delimited between the two tubular portions. Each tubular portion of the profile comprises two side walls, which are each intended to be adjacent to a glass sheet of the insulating glazing unit, and two transverse walls, which are intended to extend transversely relative to the glass sheets of the insulating glazing unit. One of the transverse walls, referred to as the inner transverse wall, is oriented toward a cavity of the insulating glazing unit whereas the other transverse wall, referred to as the outer transverse wall, is oriented toward the outside of the insulating glazing unit. Advantageously, for each profile of the spacer frame, the outer transverse walls of the various tubular portions are portions of one and the same outer transverse wall of the profile, which also defines the bottom of each groove.

Such a profile structure with at least two tubular portions enables the manufacture of multiple glazing units having at least three glass sheets. In particular, a profile with two tubular portions and one groove is suitable for the manufacture of a triple glazing unit, where two outer glass sheets are positioned on either side of the spacer frame, while a central glass sheet is received in the groove of each profile of the spacer frame. A profile with three tubular portions and two grooves is suitable for the manufacture of an insulating glazing unit with four glass sheets, where two outer glass sheets are positioned on either side of the spacer frame, while two central glass sheets are each received in a respective groove of each profile of the spacer frame. Similar configurations of insulating glazing units having more than four glass sheets may of course be obtained by increasing the number of tubular portions of the profiles of the spacer frame, and therefore the number of grooves capable of receiving a central glass sheet.

Irrespective of the number of tubular portions of the profiles of the spacer frame, and therefore the number of grooves capable of receiving a central glass sheet, the spacer frame of the insulating glazing unit is formed and assembled around the central glass sheet(s), by inserting the edges of each central glass sheet in the corresponding grooves of the profiles and by assembling the profiles in twos at their ends in the corners of the spacer frame.

In one embodiment, each profile of the spacer frame comprises a liner positioned in the groove for receiving the edge of the central glass sheet. The groove may have a width greater than the thickness of the central glass sheet. The liner is used to fasten the central glass sheet in the groove, while making it possible to compensate for possible thermal expansion variations of the central glass sheet. A stress-free fastening of the central glass sheet in the groove is thus ensured. Advantageously, the reduction of the stresses applied to the central glass sheet makes it possible to reduce the thickness and the weight of this glass sheet, relative to those used in insulating glazing units where the central glass sheet is fastened to the periphery of a spacer frame instead of being received in a groove. Installing a liner in the groove also makes it possible to adapt the profiles to various possible thicknesses of the central glass sheet. It is thus possible to use one and the same model of profile to manufacture insulating glazing units having central glass sheets of different thicknesses, without needing to produce profiles with a range of different groove widths, which is advantageous in terms of production costs. In one embodiment, the liner is configured to enable a balancing by circulation of gas between the cavities of the insulating glazing unit located on either side of the central glass sheet.

Advantageously, the liner positioned in the groove of each profile acts as a mechanical and sound damper, in particular during the insertion of the edges of the central glass sheet in the grooves of the profiles to form the spacer frame around the central glass sheet. The liner may be provided continuously along the length of the groove or discontinuously. Preferably, the liner is based on elastomer material, in particular made of ethylene-propylene-diene rubber (EPDM). The liner may be obtained as one piece with the body of the profile by coextrusion. As a variant, when the body of the profile is made of polymer material, the assembly comprising the profile and the liner positioned in the groove may be obtained as a single piece by injection molding of two polymer materials.

According to one feature, for each profile of the spacer frame, each of the tubular portions of the profile defines a housing for receiving desiccant material. Preferably, the spacer frame comprises desiccant material in the tubular portions of at least two of its constituent profiles, in order to ensure a dehydration of each cavity formed between the glass sheets of the insulating glazing unit. The inner transverse wall of each tubular portion having desiccant material in its internal volume is provided with a plurality of perforations, so as to place the desiccant material in communication with the internal air or gas of the corresponding cavity. The desiccant material may thus absorb the moisture within the cavity and prevent the formation of condensation between the glass sheets of the insulating glazing unit. The desiccant material may be any material capable of ensuring a dehydration of the air or the gas space present in the cavities of the insulating glazing unit, in particular chosen from a molecular sieve, silica gel, CaCl₂, Na₂SO₄, activated carbon, zeolites, and/or a mixture thereof. Preferably, the desiccant material is a molecular sieve and/or silica gel. The absorption capacity of these desiccant materials is greater than 20% of their weight.

Each cavity of the insulating glazing unit between the glass sheets may be filled with air. However, preferably, each cavity of the insulating glazing unit comprises a space filled with an insulating gas, which replaces the air between the glass sheets. Examples of gases used to form the insulating gas space in each cavity of the insulating glazing unit comprise, in particular, argon (Ar), krypton (Kr), xenon (Xe). Advantageously, the insulating gas space in each cavity of the insulating glazing unit comprises at least 85% of a gas having a thermal conductivity lower than that of air. Suitable gases are preferably colorless, nontoxic, noncorrosive, nonflammable, and insensitive to exposure to ultraviolet radiation.

According to one feature, for at least one profile of the spacer frame, each of the tubular portions of the profile comprises a through-orifice, intended for the flow of gases between the corresponding cavity of the insulating glazing unit and the outside of the insulating glazing unit for the filling and/or evacuation of gas into/from the cavity. The through-orifice opens into the two transverse walls of the tubular portion, which are intended to extend transversely relative to the glass sheets of the insulating glazing unit. Preferably, at least two profiles of the spacer frame comprise through-orifices, such that, in at least one configuration where the spacer frame is substantially vertical, the through-orifice of one profile among these two profiles is in a bottom position whilst the through-orifice of the other profile among these two profiles is in a top position. Such an arrangement of two through-orifices of the spacer frame is advantageous for filling each cavity of the insulating glazing unit with an insulating gas that is denser than air, by injecting the insulating gas into the cavity through the through-orifice located in a bottom position and evacuation of the air present in the cavity through the through-orifice located in a top position.

According to one feature, for the insertion of the four edges of the or each central glass sheet into the grooves of the four profiles of the spacer frame, the following steps are carried out:
each of the four profiles is positioned on movable supports of an assembly device, where the movable supports are in an initial loading configuration which is such that the four profiles on their movable supports in initial loading configuration define a frame, open at the corners, capable of surrounding a parallelepiped having the same thickness as the central glass sheet but having a length and a width which are greater than those of the central glass sheet, for example the difference in length and in width is of the order of 1 cm to 10 cm;
the central glass sheet is positioned in the assembly device so that each of its edges is facing the groove of a profile when this profile is positioned on its movable support(s) in initial loading configuration;
the four edges of the central glass sheet are inserted in the grooves of the four profiles by moving the four profiles with the aid of the movable supports of the assembly device.

The spacer frame is here assembled around the central glass sheet. The central glass sheet is used as a frame of reference for the assembly, which greatly limits the risk of geometric defects of the spacer frame appearing, in particular in comparison with the assembly processes of the prior art where the profiles of the spacer frame are positioned successively relative to one another with no frame of reference other than the profiles themselves, which may lead to an accumulation of misalignments during the assembly.

Very advantageously, the process for assembling the insulating glazing subassembly comprising the spacer frame and at least one central glass sheet may be completely automated. In particular, the step of positioning the profiles on the movable supports of the assembly device and the step of positioning the central glass sheet in the assembly device may be carried out by one or more robot grippers, whilst the step of inserting the edges of the central glass sheet into the grooves of the profiles with the aid of the movable supports and the step of welding the ends of the profiles at each corner of the spacer frame may be carried out automatically by the assembly device once it has detected that the profiles and the central glass sheet have been correctly positioned.

According to one feature, before the insertion of the four edges of the central glass sheet in the grooves of the four profiles, the central glass sheet is passed through a washing station of a plant for manufacturing insulating glazing units.

Advantageously, once assembled, the insulating glazing subassembly comprising the spacer frame and at least one central glass sheet received in an internal peripheral groove of the spacer frame is moved through successive stations of a plant for manufacturing insulating glazing units with the aid of the gripping device in accordance with the invention comprising both members for gripping the spacer frame and members for gripping the central glass sheet.

In one embodiment, once assembled, the insulating glazing subassembly comprising the spacer frame and at least one central glass sheet received in an internal peripheral groove of the spacer frame may pass successively:
through a station for depositing a seal at the periphery of the spacer frame on the two side walls of the frame, each intended to be adjacent to an outer glass sheet of the insulating glazing unit;
through a station for mounting two outer glass sheets to the spacer frame;
through a station for sealing at the outer periphery of the spacer frame between the two outer glass sheets.

According to one feature, at least one profile of the spacer frame is a profile that has been prefilled with desiccant material before the assembly of the insulating glazing subassembly comprising the spacer frame and at least one central glass sheet. In particular, the filling of the profile(s) of the spacer frame with desiccant material may be carried out in-line, in a dedicated facility for preparing the profiles, located upstream of the station for assembling the spacer frame around the central glass sheet. This facility for preparing the profiles may for example supply a profile store, in which an operator or a robot gripper picks up profiles in order to position them on the movable supports of the assembly device. Advantageously, the preparation of the profiles upstream of the station for assembling the spacer frame around the central glass sheet comprises cutting the profile to the desired length, filling the profile with a desiccant material, and optionally piercing the profile to create a gas flow through-orifice.

Another object of the invention is an insulating glazing unit obtained by the process of the invention, comprising an insulating glazing subassembly as described above and two outer glass sheets fastened on either side of the spacer frame, being substantially parallel to the central glass sheet.

Another object of the invention is a plant for manufacturing insulating glazing units, comprising:
a station for assembling an insulating glazing subassembly comprising a spacer frame and at least one central glass sheet, where the spacer frame is formed of profiles assembled angularly at their ends and each profile has a groove for receiving one edge of the central glass sheet,
a station for depositing a seal at the periphery of the spacer frame on the side walls of the frame each intended to be adjacent to an outer glass sheet of the insulating glazing unit,
a station for mounting outer glass sheets to the spacer frame,

the plant also comprising, in order to hold the insulating glazing subassembly in the assembly station and to move it from one station to another, a gripping device as described above.

According to one advantageous aspect, the plant comprises a station for positioning and measuring glass sheets, which comprises a wedging device configured to position a glass sheet in a reference position, and a measuring device configured to measure the sides of the glass sheet starting from the reference position.

The station for assembling the insulating glazing subassembly may comprise an assembly device having, on the one hand, a plurality of movable supports capable of receiving four spacer frame profiles in order to position them with their grooves gripping the edges of the central glass sheet and, on the other hand, a device for welding the ends of the profiles at each corner of the spacer frame when the profiles of the spacer frame are positioned with their grooves gripping the edges of the central glass sheet.

Advantageously, each welding device has one or two sonotrodes configured to surround the corner of the spacer frame by being applied against an outer transverse wall of each of the two profiles.

In one embodiment, the station for assembling an insulating glazing subassembly and the station for depositing a seal are stations that are located parallel to a main line comprising the station for washing glass sheets, the station for mounting outer glass sheets to the spacer frame and the station for sealing an insulating glazing unit.

The features and advantages of the invention will become apparent in the following description of embodiments of a gripping device, of a process and of a plant for manufacturing insulating glazing units according to the invention, given solely by way of example and with reference to the appended drawings, in which:

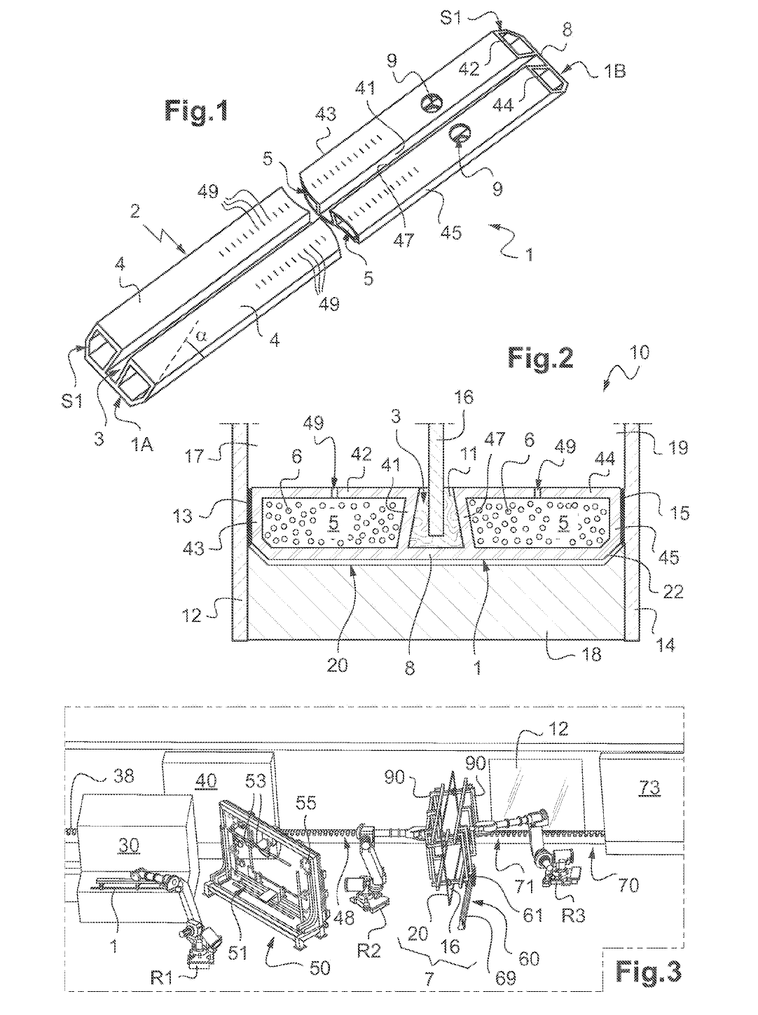

FIG. 1 is a perspective view of a spacer frame profile that can be used for the manufacture of an insulating glazing unit according to the invention;

FIG. 2 is a partial cross section of an insulating glazing unit, the spacer frame of which comprises the profile from FIG. 1;

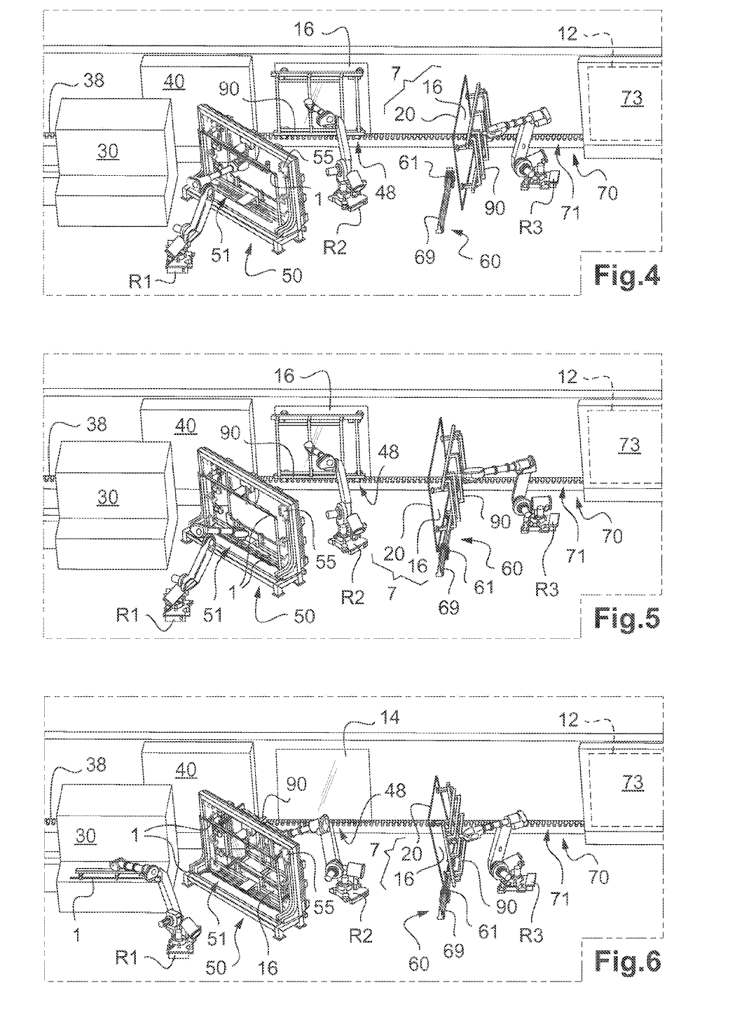

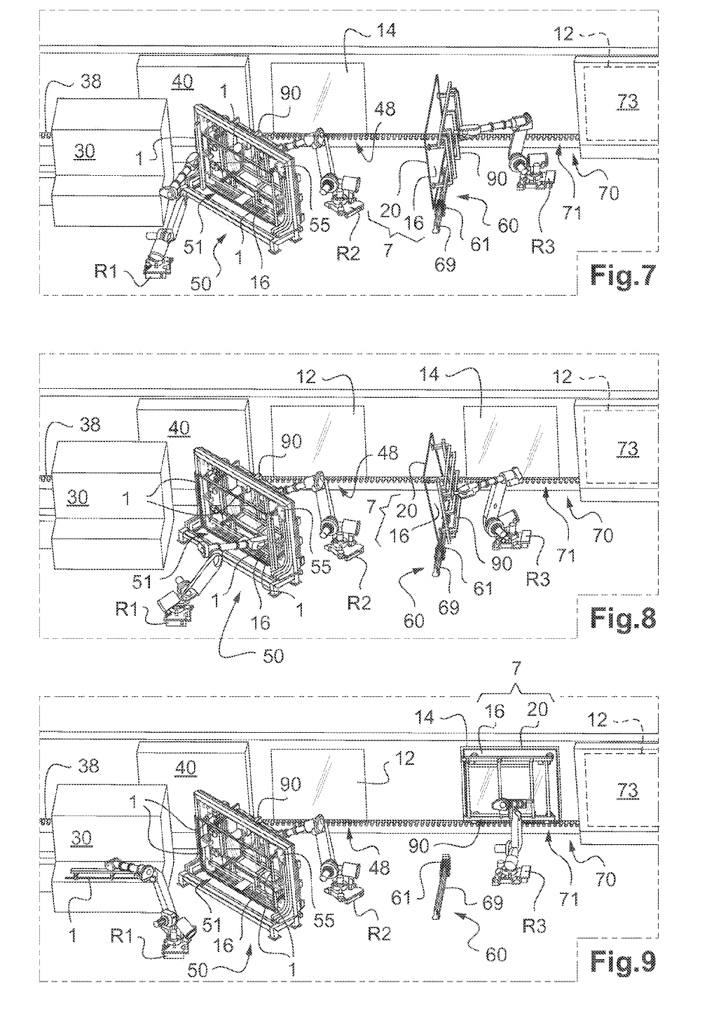

FIGS. 3 to 9 are schematic views of successive steps of a process for manufacturing insulating glazing units similar to the one shown in FIG. 2;

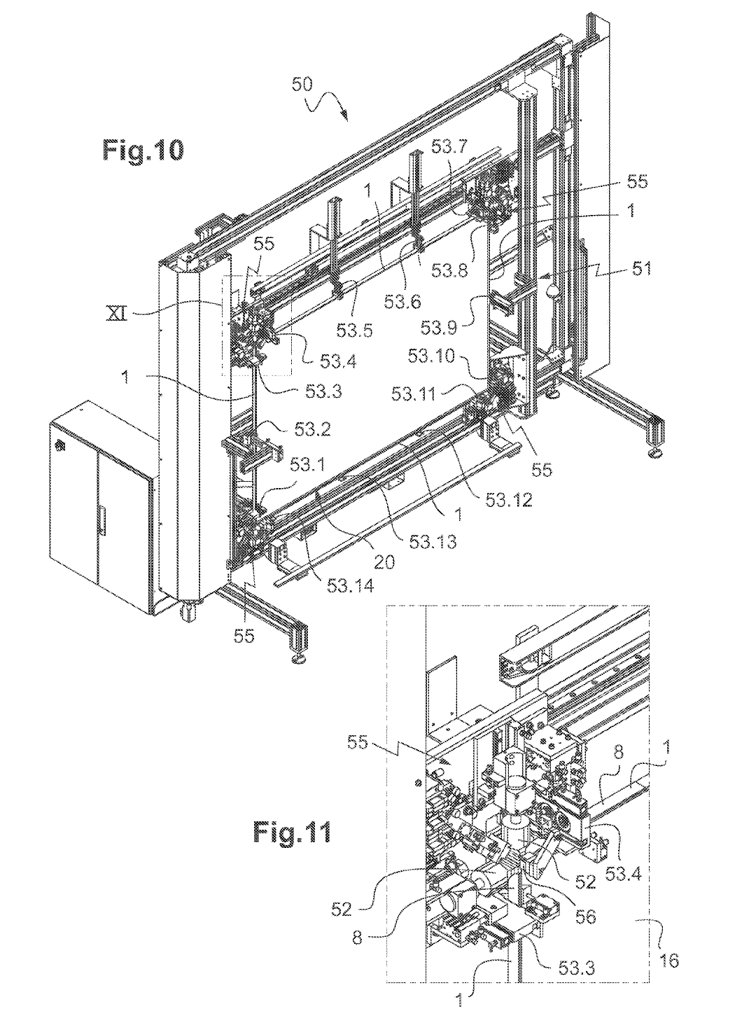

FIG. 10 is a perspective view of an assembly device used within the context of the process;

FIG. 11 is a larger-scale view of the detail XI from FIG. 10;

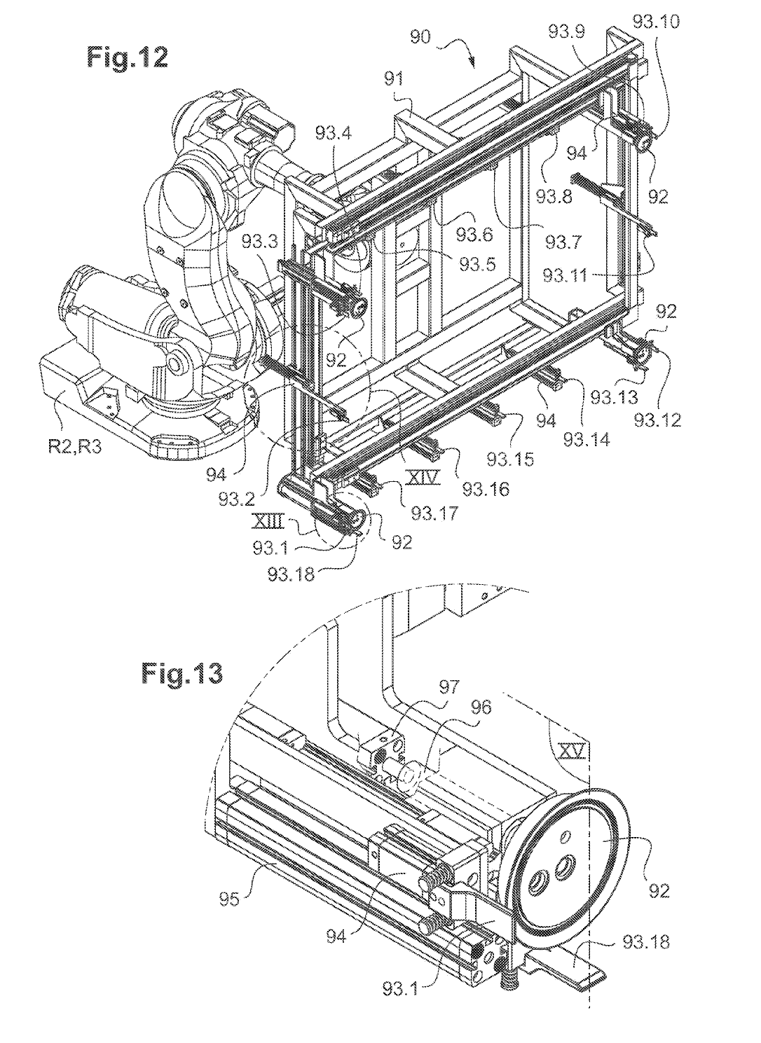

FIG. 12 is a perspective view of a robot equipped with a gripping device used within the context of the process;

FIG. 13 is a larger-scale view of the detail XIII from FIG. 12;

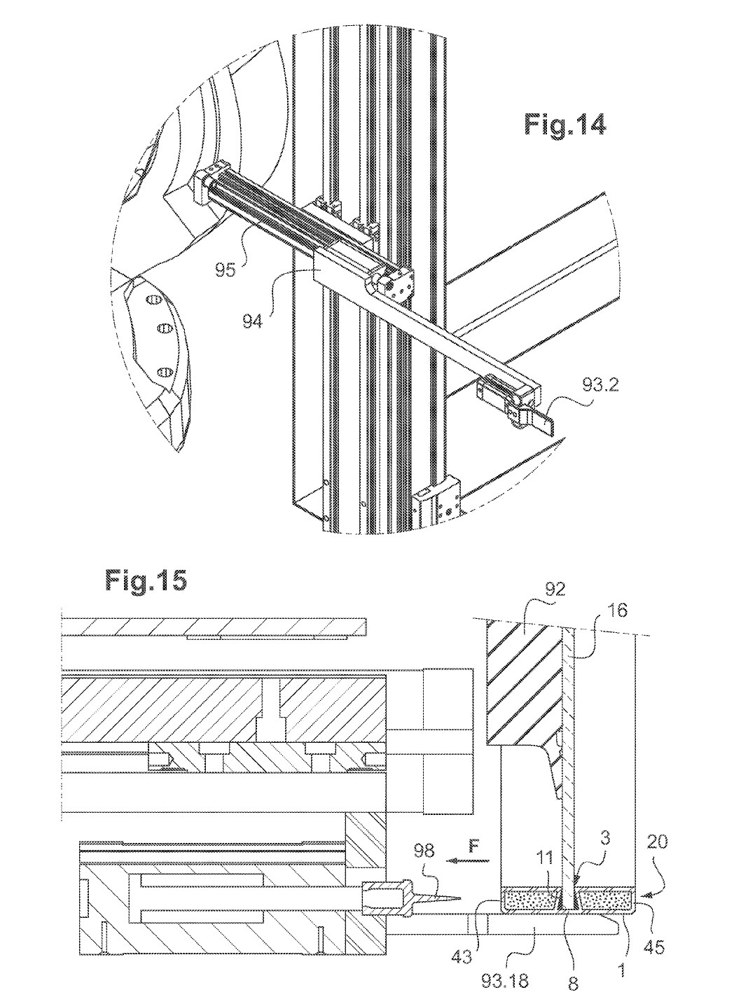

FIG. 14 is a larger-scale view of the detail XIV from FIG. 12;

FIG. 15 is a transverse cross section along the plane XV from FIG. 13;

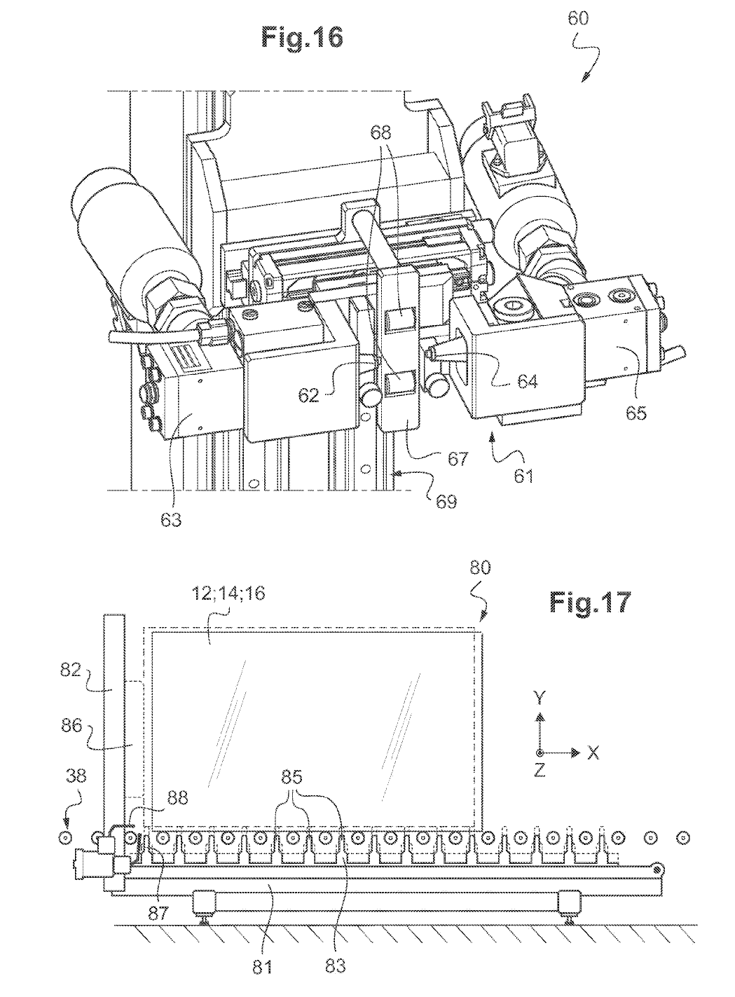

FIG. 16 is a perspective view of a seal deposition device (or butyl deposition device) used within the context of the process; and

FIG. 17 is a front view of a station for positioning and measuring glass sheets that is capable of being used for the manufacture of an insulating glazing unit according to the invention.

The figures illustrate a process and a plant for manufacturing triple glazing units 10, which comprise two outer glass sheets 12 and 14 positioned on either side of a spacer frame 20 and a central glass sheet 16 received in an internal peripheral groove of the spacer frame. The manufacture of the insulating glazing unit 10 involves the assembling of the spacer frame 20 around the central glass sheet 16, by insertion of the edges of the central glass sheet 16 in grooves 3 of the constituent profiles 1 of the spacer frame 20, then welding of the ends 1A, 1B of the profiles 1 at each corner of the spacer frame without an alignment bracket.

The spacer frame 20 is formed of four profiles 1, which are assembled as miter cut at their ends. As shown in FIG. 1, each profile 1 is formed by a body 2 comprising two juxtaposed tubular portions 4. In this example, the body 2 is made of styrene-acrylonitrile copolymer (SAN), reinforced with around 35% of glass fibers. The two tubular portions 4 define between them a groove 3 intended to receive one edge of the central glass sheet 16. Each tubular portion 4 of the profile 1 comprises two side walls, respectively 41, 43 and 45, 47. The walls 41 and 47 laterally define the groove 3 for receiving the central glass sheet 16, whilst the walls 43 and 45 are intended, in the insulating glazing unit 10, to be adjacent respectively to the outer glass sheet 12 and to the outer glass sheet 14.

Each tubular portion 4 also comprises two transverse walls which, in the insulating glazing unit 10, extend transversely relative to the glass sheets 12, 14 and 16, comprising an inner transverse wall 42 or 44 oriented toward an internal cavity 17 or 19 of the insulating glazing unit and an outer transverse wall oriented toward the outside of the insulating glazing unit. The outer transverse walls of the two tubular portions 4 are portions of an outer transverse wall 8 of the profile 1, which also defines the bottom of the groove 3. In order to reduce the heat transfer through the body 2 of the profile to the cavities 17 and 19 of the insulating glazing unit, the body 2 comprises a thermally insulating depositing 22 on the outer surface of the transverse wall 8.

The bond between each glass sheet 12 or 14 and the adjacent wall 43 or 45 of the profile 1 is provided by a respective butyl sealing bead 13 or 15. The insulating glazing unit 10 also comprises an external sealing barrier 18 made of polysulfide resin, which is applied over the entire outer perimeter of the spacer frame between the two glass sheets 12 and 14, so as to hold the glass sheets 12 and 14 together and against the spacer frame. Furthermore, the profile 1 comprises a liner 11 positioned in the groove 3 for receiving the edge of the central glass sheet 16. This liner 11 is made of EPDM and makes it possible to ensure a stress-free fastening of the central glass sheet 16 in the groove 3. The liner 11 also acts as a mechanical and sound damper, in particular during the insertion of the edges of the central glass sheet 16 in the grooves of the profiles 1 in order to form the spacer frame 20 around the central glass sheet.

Each tubular portion 4 of the profile 1 defines a housing 5, delimited by the side and transverse walls of the tubular portion, found in which is a desiccant material 6 that may be, for example, a molecular sieve or silica gel. The inner transverse walls 42 and 44 of the tubular portions 4 are provided with a plurality of perforations 49, so that the desiccant material 6 is capable of absorbing the moisture within each cavity 17 and 19 of the insulating glazing unit, which makes it possible to prevent the formation of condensation between the glass sheets 12 and 16 and between the glass sheets 14 and 16. The profile 1 also comprises two gas flow through-orifices 9, which are made in one and the other tubular portions 4 in the vicinity of the end 1B of the profile. Each through-orifice 9 opens into the two transverse walls of the corresponding tubular portion 4. Once the profile 1 is integrated in an insulating glazing unit, the through-orifices 9 may be used to fill the cavities 17 and 19 with an insulating gas and/or to evacuate air out of the cavities 17 and 19.

As is clearly visible in FIG. 1, each end face S1 of the profile 1 is inclined relative to the outer transverse wall 8 of the profile at an angle α of the order of 45°, so that the profile 1 can be assembled according to a miter cut assembly with other similar profiles 1 to form the spacer frame 20. The assembling between the ends of the profiles 1 at each corner of the spacer frame 20 is obtained, in this example, by ultrasonic welding at the end faces S1 of the profiles.

FIGS. 3 to 9 show successive steps of a process for manufacturing triple glazing units 10 that are similar to the one from FIG. 2. As can be seen in these figures, the plant for manufacturing triple glazing units 10 comprises:
a store 30 of preprepared profiles 1, in which a robot gripper R1 picks up profiles 1 to bring them to a station 50 for assembling the spacer frame 20 around the central glass sheet 16;
a station 40 for washing the glass sheets 12, 14, 16, at the outlet of which is a station 48 for inspecting the glass sheets;
a station 50 for assembling the spacer frame 20 around the central glass sheet 16, arranged in which is an assembly device 51 that comprises, on the one hand, movable supports 53 configured to hold and move the four constituent profiles 1 of the spacer frame, in order to position them with their grooves 3 gripping the edges of the central glass sheet 16 and, on the other hand, a welding device 55 comprising four ultrasonic welding heads provided to weld the ends of the profiles 1 at each of the four corners of the spacer frame;
a station 60 for butyl depositing the subassembly 7 comprising the spacer frame 20 assembled around the central glass sheet 16, in which the butyl sealing beads 13 and 15 are deposited at the periphery of the spacer frame 20, on the side walls 43 and 45 of the spacer frame against which the outer glass sheets 12 or 14 of the insulating glazing unit will be added, this butyl-depositing station 60 comprising a butyl-depositing head 61 that can be moved in translation on a rail 69;
a station 70 for mounting the two outer glass sheets 12 and 14 to the spacer frame 20, comprising, on the one hand, a first post 71 for applying the first outer glass sheet 14 to the subassembly 7 at the sealing bead 15 and, on the other hand, a second post 73 which is a press in which the second outer glass sheet 12 is applied to the subassembly 7 at the sealing bead 13; optionally, the filling of the two cavities 17 and 19 defined between the glass sheets of the triple glazing unit with insulating gas may also take place in the press 73;
a sealing station, not represented in the figures, which is located at the outlet of the press 73 and in which the external sealing barrier 18 made of polysulfide resin is applied to the outer perimeter of the spacer frame 20 between the two glass sheets 12 and 14, so as to hold the glass sheets 12 and 14 together and against the spacer frame.

The plant also comprises a conveyor belt 38, which passes through the washing station 40, the inspection station 48, the mounting station 70 and the sealing station. Furthermore, in order to hold the subassembly 7 in the assembly station 50 and to move the subassembly 7 between the assembly station 50 and the butyl-depositing station 60, then to move it within the butyl-depositing station 60, then to move it between the butyl-depositing station 60 and the post 71 of the mounting station 70, the plant comprises two robots R2 and R3.

The robots R2 and R3 are each provided with a gripping device 90 comprising both supports 93 for gripping the spacer frame 20 and suction pads 92 for gripping the central glass sheet 16. As shown in FIG. 12, the supports 93 and the suction pads 92 are borne by a frame 91 of the device 90. Very advantageously, the supports 93 and the suction pads 92 ensure an independent gripping of each of the two elements of the subassembly 7 which are the spacer frame 20 and the central glass sheet 16, while allowing in particular a relative movement of these two elements that may be necessary in certain steps for manufacturing the insulating glazing unit.

More specifically, as seen in FIGS. 12 to 14, each of the supports 93.1 to 93.18 for gripping the spacer frame 20 is fastened to an arm 94, which is itself mounted on a cylinder 95. In this example, each of the cylinders 95 is a pneumatic cylinder. Each cylinder 95 enables a retraction of the corresponding arm 94, and therefore of the support(s) 93 borne by this arm 94, when it is desirable to free up access to the periphery of the spacer frame 20.

Steps that require access to the periphery of the spacer frame 20 comprise, in particular, the step of ultrasonic welding of the ends of the profiles 1 at each corner of the spacer frame in the assembly station 50, and the step of depositing sealing beads 13 and 15 on the side walls 43 and 45 of the spacer frame in the butyl depositing station 60.

Furthermore, as can be seen in FIGS. 12 and 13, each of the four suction pads 92 for gripping the central glass sheet 16 is connected to the rod 96 of a cylinder 97. In this example, each of the cylinders 97 is a pneumatic cylinder. This arrangement of the suction pads 92 offers the choice of the possibility of a rigid gripping of the central glass sheet 16, by locking the rod of each cylinder 97 in translation, or the possibility of a flexible gripping of the central glass sheet 16, by leaving the rod of each cylinder 97 slidably movable against an elastic load that is suitably chosen so that the central glass sheet 16 can smoothly accompany the movement of the spacer frame 20 when the latter is mechanically stressed.

In particular, in order to avoid any damaging of the central glass sheet 16, a flexible gripping of the central glass sheet 16 is required when a pressing force is applied on the spacer frame 20. Steps involving a pressing force exerted on the spacer frame 20 comprise, in particular, the step of ultrasonic welding of the ends of the profiles 1 at each corner of the spacer frame in the assembly station 50, and the step of pressing the outer glass sheet 14 against the spacer frame in the post 71 of the mounting station 70.

During the pressing of the outer glass sheet 14 against the butyl-deposited side wall 45 of the spacer frame in the post 71, the spacer frame 20 tends to move in the direction of the frame 91 of the device 90, as shown by the arrow F from FIG. 15. A needle 98 is provided in the vicinity of each support 93 to create a plurality of points for bearing against the side wall 43, which is also butyl-deposited, of the spacer frame opposite the wall 45, and to thus limit the movement of the spacer frame 20 in the direction of the arrow F.

By way of example, the process for manufacturing a triple glazing unit 10 comprises steps as described below, which are illustrated in FIGS. 3 to 9.

Firstly, the constituent profiles 1 of the spacer frame 20 are prepared in a profile preparation plant, not represented, which is located upstream of the store 30 and which supplies the store 30 with profiles 1. The preparation of the profiles 1 comprises the cutting of the profile to the desired length, the shaping of its ends 1A and 1B according to a 45° bevelled shape, the filling of the two tubular portions 4 of the profile with a desiccant material 6 such as a molecular sieve or silica gel, the piercing of the profile to create a gas flow through-orifice 9 in each of the two tubular portions 4.

Four profiles 1 thus prepared are collected by the robot gripper R1 from the store 30, in order to form the spacer frame 20 of the insulating glazing unit in the assembly station 50. In the process illustrated in FIGS. 3 to 9, the robot R1 handles the profiles 1 successively, in order to position them one by one on the movable supports 53 of the device 51 which are in the initial loading configuration. As a variant, the robot R1 may of course be designed to handle several profiles 1 at once. According to another variant, the collecting of the profiles 1 from the store 30 and the positioning thereof on the movable supports 53 of the assembly device 51 may be carried out manually by an operator.

While the robot R1 positions the profiles 1 in the assembly device 51, the robot R2 will look for a central glass sheet 16 in the inspection station 48, that has previously passed through the washing station 40. The robot R2 holds the central glass sheet 16 by means of the suction pads 92 of its gripping device 90. The robot R2 moves the central glass sheet 16 from the inspection station 48 to the assembly station 50, where it positions it so that each of its edges is opposite the position that is or will be occupied by the groove 3 of a profile 1 positioned on the movable supports 53 in initial loading configuration. FIG. 8 shows a configuration of the assembly station 50 in which the robot R1 has positioned the four profiles 1 on their movable supports 53 in initial loading configuration and the robot R2 holds the central glass sheet 16 correctly positioned in the space defined between the profiles 1, with its edges opposite the grooves 3 of the profiles.

The assembly device 51 is programmed to detect this configuration and to trigger a simultaneous movement of the movable supports 53 bearing the profiles 1, so as to simultaneously insert the four edges of the central glass sheet 16 in the grooves 3 of the four profiles 1. The spacer frame 20 of the insulating glazing unit is thus formed around the central glass sheet 16. Very advantageously, the central glass sheet 16 is used as a frame of reference for the assembling of the frame 20, which greatly limits the appearance of geometric defects of the frame. The movable supports 53 hold the profiles 1 in contact with the edges of the central glass sheet 16. In particular, at each corner of the spacer frame 20, the movable supports 53 hold the end faces S1 of the profiles in a configuration where they are aligned by superposition in one and the same plane.

Starting from this configuration, the assembly device 51 automatically actuates the four welding heads 55 so that they carry out the welding of the ends of the profiles 1 at each corner of the spacer frame 20. As can be clearly seen in FIG. 11, each welding head 55 comprises two sonotrodes 52 pointed perpendicular with respect to one another, which are configured in order to surround the corner of the spacer frame 20 by each being applied against the outer transverse wall 8 of one of the two profiles 1 forming the corner. The pressing force exerted during the welding by each sonotrode 52 on the wall 8 of the corresponding profile is perpendicular to the transverse wall 8. Each welding head 55 also comprises a stop 56, which, during the welding, confines the side walls of the two profiles 1 forming the corner, so as to limit the deformations of the profiles. The central glass sheet 16 acts as the support for each of the two sonotrodes 52, by holding the two profiles 1 in a fixed position during the welding. In this example, the frequency of the ultrasonic vibration for the welding is 35 kHz.

Once the welding has been carried out at each corner of the spacer frame 20, the robot R2 removes the subassembly 7 comprising the spacer frame 20 assembled around the central glass sheet 16 from the assembly station 50 and transfers it to the robot R3 in the butyl-depositing station 60, this transfer step between the robot R2 and the robot R3 being able to be seen in FIG. 3. The robot R3 then moves the subassembly 7 by making it rotate about itself opposite the butyl-depositing head 61, which itself moves in translation along the direction of the rail 69 by moving back and forth on this rail, so as to deposit the sealing beads 13 and 15 at the periphery of the spacer frame 20 on the two side walls 43 and 45 of the frame.

As shown in FIG. 16, the structure of the butyl-depositing head 61 is adapted to enable a simultaneous butyl depositing of the two walls 43 and 45, owing to the presence of two injection nozzles 62 and 64 each connected to a respective butyl reservoir 63 or 65. The two injection nozzles 62 and 64 are positioned on either side of a carriage 67 equipped with two rollers 68, which are provided to move along the outer transverse wall 8 of the frame 20 while the two injection nozzles 62 and 64 deposit the butyl beads 13 and 15 on the walls 43 and 45.

When the spacer frame 20 of the subassembly 7 has been butyl deposited over its entire periphery, the robot R3 moves the subassembly 7 to the post 71 of the mounting station 70, where a first outer glass sheet 14 is waiting. The outer glass sheet 14 is then pressed against the butyl-deposited side wall 45 of the spacer frame which is still held, in the same way as the glass sheet 16, by the robot R3 with the aid of its gripping device 90. The assembly comprising the glass sheet 14 and the subassembly 7, which are attached at the butyl bead 15, is then conveyed on the conveyor belt 38 into the press 73, where a second outer glass sheet 12 is applied to the subassembly 7 at the butyl bead 13. The filling with insulating gas of the two cavities 17 and 19 defined between the glass sheets 12, 14, 16 may also take place in the press 73, before the assembly is transferred to a sealing station, not visible in the figures, which is located at the outlet of the press 73 and in which the external sealing barrier 18 made of polysulfide resin is applied to the outer perimeter of the spacer frame 20 between the outer glass sheets 12 and 14.

As it emerges from FIGS. 3 to 9, in this embodiment, the assembly station 50 and the butyl-depositing station 60 are stations located in parallel with a main line comprising the conveyor belt 38 which passes through the washing station 40, the inspection station 48, the mounting station 70 and the sealing station. Of course, other configurations of the plant can be envisaged. In particular, according to one variant, the butyl-depositing station 60 may involve a conveyor belt parallel to the conveyor belt 38 of the main line instead of a robot gripper.

Furthermore, according to another variant, it may be envisaged to replace the assembly of the inspection station 48 and of the post 71 of the mounting station 70 by a single station 80 for positioning and measuring glass sheets, as shown for example in FIG. 17, which is located on the main line comprising the conveyor belt 38 and which is associated with a single robot similar to the robot R2 described previously instead of two robots R2 and R3. The positioning and measuring station 80 makes it possible to position a glass sheet 12, 14, 16 in a reference position (shown by dotted lines in FIG. 17) and to measure the sides of the glass sheet 12, 14, 16 along two orthogonal directions X and Y, which are in particular a horizontal direction X and a vertical direction Y, and also optionally along the thickness direction Z of the glass sheet.

In the example shown in FIG. 17, the positioning and measuring station 80 comprises a frame having a horizontal portion 81, which supports a horizontal wedging device 83 making it possible to define the reference position along the vertical direction Y, and a vertical portion 82, that supports a vertical wedging device 86 making it possible to define the reference position along the horizontal direction X.

The horizontal wedging device 83 comprises a plurality of wedges 85 positioned between the rollers of the conveyor belt 38 and attached to one and the same support that is movable between a low position, visible as solid lines in FIG. 17, in which the wedges 85 are set back relative to the surface of the rollers of the conveyor belt 38 so that a glass sheet 12, 14, 16 can be brought by the conveyor belt 38 to the station 80, and a high position, visible as dotted lines in FIG. 17, in which the wedges 85 jut out in the Y direction relative to the surface of the rollers of the conveyor belt 38. During the movement of the wedges 85 from the low position to the high position, a glass sheet 12, 14, 16 received in the station 80 and bearing via its lower edge against the wedges 85 is moved vertically to the reference position.

The vertical wedging device 86 comprises a single wedge, which is movable between a retracted position, in which the wedge 86 is set back relative to the zone of movement of glass sheets on the rollers of the conveyor belt 38, so that a glass sheet 12, 14, 16 can be brought by the conveyor belt 38 to the station 80, and a deployed position, visible as dotted lines in FIG. 17, in which the wedge 86 juts out in the X and Z directions relative to the portion 83 of the frame. In the deployed position of the wedge 86, a glass sheet 12, 14, 16 received in the station 80 may be moved horizontally to the reference position in order to bear via its left side edge against the wedge 86.

The station 80 also comprises measurement heads for measuring the dimensions of a glass sheet 12, 14, 16 received in the station 80 in the reference position, comprising a head 87 for measuring the dimension along the horizontal direction X and a head 88 measuring the dimension along the vertical direction Y. Generally, the measurement of the dimensions along the X, Y, Z directions of a glass sheet received in the station 80 may be carried out on the fly, by a mobile sensor, etc. The precise measurement of the dimensions along the X, Y, Z directions of each glass sheet used for the manufacture of an insulating glazing unit 10, starting from the reference position, makes it possible in particular to:
ensure a consistency between the dimensions of the central glass sheet 16 and the dimensions of the profiles 1 that are collected from the store 30 and positioned in the assembly station 50 by the robot R1 in order to form the spacer frame 20;
have a precise focusing of each glass sheet 12, 14, 16 of the insulating glazing unit 10;
take into account any discrepancies possibly measured in order to correct the manufacturing parameters in the plant for preparing the profiles 1 upstream of the store 30 and/or in the butyl-depositing station 60 and/or in the station where the first outer glass sheet 14 is pressed against the butyl-deposited side wall 45 of the spacer frame.

By way of example, the process for manufacturing a triple glazing unit 10 using the station 80 shown in FIG. 17, instead of the inspection station 48 and the post 71 of the mounting station 70, and a single robot similar to the robot R2 described previously, instead of two robots R2 and R3, comprises steps as described below.

A central glass sheet 16, previously passed through the washing station 40, is brought to the station 80 by the conveyor belt 38, then is positioned in the reference position by means of the horizontal wedging device 83 and vertical wedging device 86. More specifically, once the central glass sheet 16 has arrived at the station 80, the portion of the conveyor belt 38 positioned in the station 80 is immobilized, the vertical wedge 86 is deployed, the rollers of the portion of the conveyor belt 38 positioned in the station 80 make a slight backward movement so as to bring the left vertical edge of the glass sheet 16 to bear against the wedge 86, the wedges 85 of the horizontal wedging device are moved into the high position with the glass sheet 16 bearing via its lower edge against the wedges 85. The central glass sheet 16 is then in the reference position, and the measurement heads 87, 88 carry out the measurement of the dimensions along the X, Y, Z directions of the central glass sheet 16 in the reference position. The data from the measurements along the X, Y, Z directions of the central glass sheet 16 in the reference position are sent to the plant for preparing the profiles 1 upstream of the store 30 in order to verify and/or adjust the dimensions of the profiles 1.

While the robot R1 positions the profiles 1 in the assembly device 51, the robot R2 will look for the central glass sheet 16 in the reference position in the station 80, by means of the suction pads 92 of its gripping device 90. The robot R2 then positions the central glass sheet 16 in the assembly station 50, and the process in the assembly station 50 continues in a similar manner to that which was described above with reference to FIGS. 3 to 9.

Once the welding has been carried out at each corner of the spacer frame 20, the robot R2 removes the subassembly 7 comprising the spacer frame 20 assembled around the central glass sheet 16 from the assembly station 50 and positions it in the butyl-depositing station 60, where it moves it opposite the butyl-depositing head 61, so as to deposit the sealing beads 13 and 15 at the periphery of the spacer frame 20 on the two side walls 43 and 45 of each of the four sides of the frame.

When the spacer frame 20 of the subassembly 7 has been butyl-deposited over its entire periphery, the robot R2 brings the subassembly 7 back to the station 80, where a first outer glass sheet 14 is waiting in the reference position. In the station 80, the measurement of the dimensions along the X, Y, Z directions of the outer glass sheet 14 in the reference position has taken place, which makes it possible to adapt the parameters for the pressing of the outer glass sheet 14 against the butyl-deposited side wall 45 of the spacer frame of the subassembly 7 held by the robot R2. The outer glass sheet 14 is then pressed against the butyl-deposited side wall 45 of the spacer frame which is still held, in the same way as the glass sheet 16, by the robot R2 with the aid of its gripping device 90. The assembly comprising the glass sheet 14 and the subassembly 7, which are attached at the butyl bead 15, is then conveyed on the conveyor belt 38 into the press 73, where a second outer glass sheet 12 is applied to the subassembly 7 at the butyl bead 13, as described above with reference to FIGS. 3 to 9.

As it emerges from the preceding examples, the process according to the invention may be carried out in a completely automated manner, which makes it possible to increase the productivity and to reduce the production costs of insulating glazing units containing at least three glass sheets. The process according to the invention also has the advantage of guaranteeing a precise positioning of the end faces of the profiles of the spacer frame, by means of the assembling of the frame around at least one central glass sheet, which makes it possible to limit the appearance of geometric defects of the spacer frame and therefore to ensure a good durability of the insulating glazing units.

The invention is not limited to the examples described and represented. In particular, the process according to the invention has been described in the case where it is completely automated, but it is of course possible to carry out the invention with a partial automation, or even without automation. Furthermore, the invention has been described with an assembling of the profiles of the spacer frame at their ends by ultrasonic welding. Other assembly techniques are however also possible, as long as they are compatible with the fact that the spacer frame is assembled around at least one central glass sheet. As already mentioned, the number of tubular portions of the profiles of the spacer frame may also be greater than two, with a groove defined by each pair of adjacent tubular portions, which enables the manufacture of insulating glazing units comprising four or more glass sheets. In this case, the process for manufacturing the insulating glazing unit may be similar to that described above for the manufacture of triple glazing units, with the difference that the assembling of the spacer frame no longer takes place around a single central glass sheet, but several juxtaposed central glass sheets.

1. A gripping device, configured to hold an insulating glazing subassembly comprising a spacer frame and at least one central glass sheet received in an internal peripheral groove of the spacer frame, the gripping device comprising, on the one hand, members for gripping the spacer frame and, on the other hand, members for gripping the central glass sheet so as to ensure an independent gripping of the spacer frame and of the central glass sheet while allowing a relative movement of one with respect to the other.

2. The gripping device as claimed in claim 1, wherein each member for gripping the spacer frame is mounted on a retractable arm so as to free up access to the periphery of the spacer frame.

3. The gripping device as claimed in claim 1, wherein each member for gripping the spacer frame is borne by a frame of the gripping device.

4. The gripping device as claimed in claim 3, comprising a bearing element in the vicinity of each member for gripping the spacer frame, the bearing element being intended to create a point for bearing against a side wall of the spacer frame so as to limit a movement of the spacer frame in a direction of the frame of the gripping device.

5. The gripping device as claimed in claim 4, wherein each bearing element is suitable for not degrading a seal optionally present on the side wall of the spacer frame that it supports.

6. The gripping device as claimed in claim 1, each member for gripping the central glass sheet is mounted on an actuator, with a possibility of elastic releasing of the rod of the actuator so that the member for gripping the central glass sheet allows the central glass sheet to accompany the movement of the spacer frame when the spacer frame is mechanically stressed.

7. The gripping device as claimed in claim 6, wherein each member for gripping the central glass sheet ensures a rigid gripping of the central glass sheet when the rod of the actuator is prevented from moving in translation.

8. The gripping device as claimed in claim 6, wherein each member for gripping the central glass sheet ensures a flexible gripping of the central glass sheet when the rod of the actuator is left slidingly movable against an elastic load which is suitably chosen so that the central glass sheet smoothly accompanies the movement of the spacer frame when the spacer frame is mechanically stressed.

9. The gripping device as claimed in claim 1, wherein each member for gripping the central glass sheet is a suction pad borne by a frame of the gripping device.

10. The gripping device as claimed in claim 1, wherein the gripping device is configured to hold the insulating glazing subassembly in a station for assembling the spacer frame around the central glass sheet.

11. The gripping device as claimed in claim 1, wherein the gripping device is configured to move the insulating glazing subassembly through a plant for manufacturing insulating glazing units.

12. A process for manufacturing an insulating glazing unit, comprising assembling of an insulating glazing subassembly which comprises a spacer frame and at least one central glass sheet, and moving the insulating glazing subassembly through a plant for manufacturing insulating glazing units, the insulating glazing subassembly being held during at least some steps of the process with the aid of a gripping device as claimed in claim 1.

13. The process as claimed in claim 12, comprising:
assembling ends of constituent profiles of the spacer frame at each corner of the spacer frame when the profiles are gripping the edges of the central glass sheet,
depositing a seal at a periphery of the spacer frame on each side wall of the spacer frame intended to be adjacent to an outer glass sheet of the insulating glazing unit,
and wherein, during the assembling of the spacer frame and the depositing of the seal, the insulating glazing subassembly is held with the aid of the gripping device in a configuration where each member for gripping the spacer frame is retracted so as to free up access to the periphery of the spacer frame.

14. The process as claimed in claim 12, comprising:
assembling ends of constituent profiles of the spacer frame at each corner of the spacer frame when the profiles are gripping the edges of the central glass sheet,
mounting at least one outer glass sheet to the spacer frame by pressing the outer glass sheet against a corresponding side wall of the spacer frame,
and wherein, during the assembling of the spacer frame and the mounting of the outer glass sheet, the insulating glazing subassembly is held with the aid of the gripping device in a configuration where each member for gripping the central glass sheet provides a flexible gripping of the central glass sheet, so that the central glass sheet smoothly accompanies the movement of the spacer frame.

15. A plant for manufacturing insulating glazing units, comprising:
a station for assembling an insulating glazing subassembly comprising a spacer frame and at least one central glass sheet, where the spacer frame is formed of profiles angularly assembled at their ends and each profile has a groove for receiving one edge of the central glass sheet,
a station for depositing a seal at a periphery of the spacer frame on side walls of the frame each intended to be adjacent to an outer glass sheet of the insulating glazing unit,
a station for mounting outer glass sheets to the spacer frame, and, in order to hold the insulating glazing subassembly in the assembly station and to move the insulating glazing subassembly from one station to another, a gripping device as claimed in claim 1.

16. The plant as claimed in claim 15, comprising a station for positioning and measuring glass sheets, which comprises a wedging device, configured to position a glass sheet in a reference position, and a measuring device, configured to measure the sides of the glass sheet starting from the reference position.

17. The gripping device as claimed in claim 4, wherein the bearing element is arranged to create a point for bearing against a side wall of the spacer frame so as to limit a movement of the spacer frame in the direction of the frame of the gripping device during a pressing step.

18. The gripping device as claimed in claim 5, wherein each bearing element is a needle.

19. The process as claimed in claim 13, wherein the assembling is by welding.

20. The process as claimed in claim 14, wherein the assembling is by welding.
